(19) United States
(12) Patent Application Publication
(10) Pub. No.: US 2014/0342150 A1
(43) Pub. Date: Nov. 20, 2014

(54) NON-ORIENTED ELECTRICAL STEEL SHEET

(71) Applicant: Takeaki Wakisaka, Tokyo (JP)

(72) Inventor: Takeaki Wakisaka, Tokyo (JP)

(73) Assignee: Nippon Steel & Sumitomo Metal Corporation, Tokyo (JP)

(21) Appl. No.: 14/362,167

(22) PCT Filed: May 31, 2012
(86) PCT No.: PCT/JP2012/064062

§ 371 Date: Jun. 2, 2014

(51) Int. Cl. H01F 1/147

(52) U.S. Cl. CPC H01F 1/14783
USPC 428/336

(57) ABSTRACT

A non-oriented electrical steel sheet includes: C: 0.005 mass % or less; S: 0.003 mass % or less; N: 0.003 mass % or less; Si: 2.0 mass % or more and less than 4.5 mass %; Al: 0.15 mass % or more and less than 2.5 mass %; and Cr: 0.3 mass % or more and less than 5.0 mass %; and a balance being composed of Fe and inevitable impurities; and a Cr-oxide-containing layer having a thickness of not less than 0.01 μm nor more than 0.5 μm on a surface side, in which when [Si], [Al], and [Cr] are set to the Si content, the Al content, and the Cr content (mass %) of the non-oriented electrical steel sheet respectively, and t is set to a sheet thickness (mm) of the non-oriented electrical steel sheet, 10 mass %≦2[Si]+2[Al]+[Cr]<15 mass % and (2[Al]+[Cr])/2[Si]−10t²≦0.35 are satisfied.

### TECHNICAL FIELD

The present invention relates to a non-oriented electrical steel sheet suitable as a material of a motor core, particularly a motor core to be rotated at high speed and to be driven at high frequency in an electric vehicle, a hybrid vehicle, and the like.

### BACKGROUND ART

In recent years, a lot of electric vehicles and hybrid vehicles have become widespread, and as for a driving motor used for these vehicles, high-speed rotation has advanced and high-frequency driving by an inverter has advanced. In order to make the driving motor rotate at high speed and drive at high frequency, a high-frequency core loss has been required to be decreased in a non-oriented electrical steel sheet used as a motor core.

For decreasing the high-frequency core loss in the non-oriented electrical steel sheet, it is effective to decrease a sheet thickness and have high resistivity by high alloying. However, when the sheet thickness is decreased, in a steel maker, productivity decreases, and in a motor maker, cost for performing stamping and cost for laminating are increased. Further, there are also problems such that by thinning, core rigidity is decreased, fixing the lamination becomes difficult, and so on. For this reason, from a balance between a required core loss property and cost, the sheet thickness of a product is selected.

For increasing the resistivity by high alloying, Si, Al, and Mn are generally used. However, when Si and Al are added, there is a problem that the hardness of the steel sheet increases and the steel sheet becomes brittle, and thereby the productivity deteriorates, and thus there are upper limits in additive amounts. Further, in the case of Mn being added, an increase width of the hardness of the steel sheet is small, but an effect of increasing the resistivity is almost half as compared with Si and Al. Further, in hot rolling, a problem of red shortness is sometimes caused, and thus there is an upper limit in an additive amount.

Thus, as another technique of increasing the resistivity, in Patent Literature 1, for example, there has been disclosed a technique of increasing resistivity by adding 1.5% to 20% of Cr. An effect of increasing the resistivity in the case of Cr being added is substantially equal to that of Mn, but as long as 20% or less of Cr is added, the hardness of a steel sheet does not increase so much and a concern of embrittlement is low. Further, unlike Mn, the problem of red shortness is also small.

By the way, the driving motor of an electric vehicle and a hybrid vehicle is used not only for high-speed running, but also for low-speed high-torque running at the time of start and at the time of running uphill, and further it is conceivable that the running speed is an intermediate speed between them in a high-frequency running area where high efficiency is required. For that reason, in the electrical steel sheet for a motor core, not only the decrease in core loss at high frequency but also a decrease in core loss at low frequency is required.

However, as a result that present inventors examined the disclosed technique in Patent Literature described above in detail, in the technique in Patent Literature 1, a core loss at a fixed frequency or higher, for example, at 3000 Hz is good, but at low frequency such as, for example, 800 Hz, there is a problem that with an increase in additive amount of Cr, the core loss deteriorates. Further, it was also found that depending on the sheet thickness of a product, the frequency at which the core loss starts to deteriorate changes.

### CITATION LIST

### Patent Literature

Patent Literature 1: Japanese Laid-open Patent Publication No. 2001-26823

Patent Literature 2: Japanese Laid-open Patent Publication No. 2003-183788

Patent Literature 3: Japanese Laid-open Patent Publication No. 2002-317254

Patent Literature 4: Japanese Laid-open Patent Publication No. 2002-115035

### SUMMARY OF INVENTION

### Technical Problem

The present invention has been made in consideration of the previously described problems, and has an object to provide a non-oriented electrical steel sheet excellent in core loss over wide frequencies.

### Solution to Problem

Thus, as a result of repeated earnest examinations for solving the above-described problems, the present inventors obtained the knowledge in which a ratio of Si, Al, and Cr in mass %, together with a sheet thickness of a product, satisfies certain expressions, and thereby the desired object is achieved. That is, the gist and constitution of the present invention are as follows.

(1) A non-oriented electrical steel sheet includes:

C: 0.005 mass % or less; S: 0.003 mass % or less; N: 0.003 mass % or less; Si: 2.0 mass % or more and less than 4.5 mass %; Al: 0.15 mass % or more and less than 2.5 mass %; and Cr: 0.3 mass % or more and less than 5.0 massa; and a balance being composed of Fe and inevitable impurities; and a Cr-oxide-containing layer having a thickness of not less than 0.01 μm nor more than 0.5 μm on a surface side, in which

Expression 1 and Expression 2 below are further satisfied.

10 mass %≦2[Si]+2[Al]+[Cr]<15 mass % Expression 1

(2[Al]+[Cr])/2[Si]−10t²≦0.35 Expression

(Here, [Si], [Al], and [Cr] represent the Si content, the Al content, and the Cr content (mass %) of the non-oriented electrical steel sheet respectively, and t represents a sheet thickness (mm) of the non-oriented electrical steel sheet.)

(2) The non-oriented electrical steel sheet according to (1), in which

Expression 3 below is further satisfied.

(2[Al]+[Cr])/2[Si]−5t²≦0.35 Expression 3

(3) The non-oriented electrical steel sheet according to (1) further includes:

Mn: not less than 0.2 mass % nor more than 1.5 mass %.

### Advantageous Effects of Invention

According to the present invention, it is possible to provide a non-oriented electrical steel sheet excellent in core loss over wider frequencies.

### DESCRIPTION OF EMBODIMENTS

Hereinafter, the present invention will be explained in detail. First, there will be explained reasons for limiting ranges of a chemical composition in the present invention.

Si is an effective element for decreasing a high-frequency core loss by increasing resistivity of a steel sheet and decreasing an eddy current loss. The Si content is set to 2 mass % or more and less than 4.5 mass %. If the Si content is less than 2 mass %, the resistivity cannot be increased sufficiently to thereby make it impossible to sufficiently obtain an effect of decreasing the core loss. On the other hand, Si decreases a saturation magnetic flux density of the steel sheet, and thus if the Si content exceeds 4.5 mass %, the saturation magnetic flux density is decreased significantly and a decrease in B50 (magnetic flux density at 5000 A/m of excitation magnetizing force) being one of indexes of material properties of the non-oriented electrical steel sheet becomes significant.

Al is an effective element for decreasing the high-frequency core loss by increasing the resistivity of the steel sheet, similarly to Si, and the Al content is set to 0.3 mass % or more and less than 2.5 mass %. If the Al content is less than 0.3 mass %, the resistivity cannot be increased sufficiently to thereby make it impossible to sufficiently obtain an effect of decreasing the core loss. On the other hand, Al decreases the saturation magnetic flux density of the steel sheet, and thus if the Al content exceeds 2.5 mass %, the saturation magnetic flux density is decreased significantly and the decrease in B50 becomes significant.

Cr has a smaller beneficial effect than Si and Al, but is an effective element for decreasing the high-frequency core loss by increasing the resistivity of the steel sheet, and the Cr content is set to 0.3 mass % or more and less than 5 mass %. If the Cr content is less than 0.3 massa, the resistivity cannot be increased sufficiently to thereby make it impossible to sufficiently obtain an effect of decreasing the core loss. On the other hand, Cr decreases the saturation magnetic flux density of the steel sheet, and thus if the Cr content exceeds 5 mass %, the saturation magnetic flux density is decreased significantly and the decrease in B50 becomes significant.

Further, in the relation of Si, Al, and Cr in mass %, the condition of 10 mass %≦2[Si]+2[Al]+[Cr]<15 mass % is designed to be satisfied. Here, [Si], [Al], and [Cr] represent the Si content, the Al content, and the Cr content (mass %) of the non-oriented electrical steel sheet respectively. If 2[Si]+2[Al]+[Cr] is less than 10 mass %, the core loss at 3000 Hz becomes too large. On the other hand, if it exceeds 15 mass %, the saturation magnetic flux density of the steel sheet is decreased significantly and the decrease in B50 becomes significant. Incidentally, the reason why the specific gravity of Si and the specific gravity of Al are set to be twice as large as that of Cr is based on the fact that the beneficial effect of Cr is small.

The ratio of Si, Al, and Cr in mass %: (2[Al]+[Cr])/2[Si] is designed to satisfy certain expressions to be explained below with respect to a sheet thickness of a product and a targeted frequency. As a result of repeated experiments conducted by present inventors, it was found that even though the Si content is increased, a hysteresis loss does not deteriorate so much, but if the Al content and the Cr content are increased, the hysteresis loss deteriorates rapidly. As a result, it was found out that even with the substantially equal resistivity and sheet thickness, namely even with the substantially equal eddy current loss, if the ratio of (2[Al]+[Cr])/2[Si] is increased, the core loss deteriorates, namely the hysteresis loss deteriorates.

Further, as a result of a further experiment, this tendency became more significant in a low-frequency region where the proportion of the hysteresis loss increases, or even in a high-frequency region when the sheet thickness was decreased and the eddy current loss was decreased. It is conceivable that the eddy current loss is proportional to the square of the frequency and the square of the sheet thickness and the hysteresis loss is proportional to the first power of the frequency but does not rely on the sheet thickness. Thus, the following expressions were derived based on experimental data.

(2[Al]+[Cr])/2[Si]−10t²≦0.35

Here, t represents the sheet thickness (mm) of the non-oriented electrical steel sheet being the product.

Further, in order to improve the core loss in a lower frequency region (for example, 400 Hz), it is preferred that the condition of the following expression should be designed to be further satisfied.

(2[Al]+[Cr])/2[Si]−5t²≦0.35

C, S, and N are impurity elements for the non-oriented electrical steel sheet of the present invention, and the smaller they are, the more desirable it is.

C is an element that precipitates in the steel sheet as carbide to make a growth potential of crystal gains and the core loss deteriorate. Thus, the C content is set to 0.005 mass % or less. If the C content exceeds 0.005 mass %, the growth potential of crystal grains deteriorates and the core loss deteriorates. Further, for suppressing magnetic aging, the C content is preferably set to 0.003 mass % or less. Its lower limit is not limited in particular, but it is difficult to set the lower limit to 0.001 mass % or less in a normal manufacturing method.

S is an element that precipitates in the steel sheet as sulfide to make the growth potential of crystal gains and the core loss deteriorate. Thus, the S content is set to 0.003 mass % or less. If the S content exceeds 0.003 mass %, the growth potential of crystal grains deteriorates and the core loss deteriorates. Its lower limit is not limited in particular, but it is difficult to set the lower limit to 0.0005 mass % or less in a normal manufacturing method.

The N content is set to 0.003 mass % or less. If the N content exceeds 0.003 mass %, a blister-shaped surface defect, which is called a blister, is caused. Its lower limit is not limited in particular, but it is difficult to set the lower limit to 0.001 mass % or less in a normal manufacturing method.

Further, other elements may also be contained according to the object.

In the case of Mn being contained, the Mn content is preferably set to 1.5 mass % or less. Although the beneficial effect of Mn is also small, Mn increases the resistivity of the steel sheet, but if the Mn content exceeds 1.5 mass %, there is a possibility that the steel sheet becomes brittle. Its lower limit is not limited in particular, but the lower limit is further preferably 0.2 mass % or more from the viewpoint of suppressing fine precipitation of sulfide.

Besides, well-known additive elements are allowed to be contained for the purpose of improving the magnetic property and the like. As this example, 0.20 mass % or less of at least one type of Sn, Cu, Ni, and Sb may also be contained.

Next, there will be explained a manufacturing method of the non-oriented electrical steel sheet having the characteristics as above.

First, a molten steel made of the same components as those of the product explained above is cast to make a slab, and the made slab is reheated and is subjected to hot rolling, to thereby obtain a hot-rolled sheet. Incidentally, in making the slab, a thin slab may be made by a rapid cooling solidification method, or a thin steel sheet may also be cast directly to thereby obtain a hot-rolled sheet.

Next, on the obtained hot-rolled sheet, normal pickling is performed, and then cold rolling is performed, to thereby obtain a cold-rolled sheet. Incidentally, hot-rolled sheet annealing may also be performed before performing the pickling, for the purpose of improving the magnetic property. The hot-rolled sheet annealing may be continuous annealing or may also be batch annealing, and is performed at a temperature and for a period of time allowing a crystal grain diameter suitable for the improvement of the magnetic property to be obtained.

The cold rolling is normally performed in reverse or in tandem, but a reverse mill such as a Sendzimir mill makes it possible to obtain the higher magnetic flux density, and thus is preferred. Further, if Si and Al are too large, the steel sheet becomes brittle, and thus as measures against brittle fracture, warm annealing may also be performed. Then, by the cold rolling, the hot-rolled sheet is rolled to the sheet thickness of the product. From the viewpoint of decreasing the high-frequency core loss, the thickness is preferably set to 0.1 mm 0.35 mm. Further, in the cold rolling, intermediate annealing may also be performed one time or more.

The hot-rolled sheet is cold rolled to the sheet thickness of the product, and then is subjected to finish annealing. In the finish annealing, a sufficient temperature for making crystal grains recrystallized and grain-grown is needed, and the finish annealing is normally performed at 800° C. to 1100° C. By this finish annealing, a Cr oxide layer is formed on the surface of the steel sheet.

The Cr oxide is thin and has an extremely dense structure, and it is conceivable that when the Cr oxide layer is formed on the surface of the steel sheet, invasion of oxygen thereafter is prevented and thereby internal oxidation of Si and Al is suppressed. Si and Al in the steel sheet are likely to be oxidized, and thus if at high temperature, oxygen is diffused in the steel sheet and thereby the internal oxidation occurs, domain wall displacement is prevented and the hysteresis loss is deteriorated. Further, if the internal oxidation occurs, due to the existence of a nonmagnetic oxide layer, an effective cross-sectional area through which magnetic flux can pass is decreased to thereby increase the magnetic flux density and also deteriorate the eddy current loss. Further, at high frequency, the magnetic flux concentrates in the vicinity of a surface layer of the steel sheet by the skin effect, so that the above-described effect becomes more significant.

In consideration of the above, the thickness of the Cr oxide layer formed on the surface of the steel sheet is designed to be not less than 0.01 μm nor more than 0.5 μm. If the thickness of the Cr oxide layer is less than 0.01 μm, the effect of preventing the invasion of oxygen to thereby suppress the internal oxidation of Si and Al is insufficient. Further, if the thickness of the Cr oxide layer exceeds 0.5 μm, an adverse effect on the magnetic property starts to appear. In order to set the thickness of the Cr oxide layer to not less than 0.01 μm nor more than 0.5 μm, in the finish annealing after the cold rolling, an oxygen potential is set to a low-oxygen potential in the entire annealing, and even at the time of increasing the temperature, the oxygen potential is set to a low-oxygen potential. For example, at 300° C. to 500° C. at the time of increasing the temperature, the oxygen potential is set to P_{H2O}/P_{H2}≦10⁻³.

After the finish annealing, normally, a film for the purpose of insulation is applied to be baked. As long as the film is insulative, it does not impede the effect of the present invention even if it is totally organic, totally inorganic, or a mixture of an organic matter and an inorganic matter, and thus the film is not limited in particular.

### EXAMPLE

Next, there will be explained experiments conducted by the present inventors. Conditions and so on in these experiments are examples employed for confirming the applicability and effects of the present invention, and the present invention is not limited to these examples.

### Example 1

First, hot-rolled sheets each containing C: 0.002 mass %, S: 0.002 mass %, N: 0.002 mass %, and Mn: 0.3 mass %, and each having a composition of Si, Al, and Cr shown in Table 1 below were prepared and were each subjected to pickling to be cold rolled, to thereby obtain cold-rolled sheets each having a thickness of 0.25 mm. Next, under the conditions shown in Table 1, an oxygen potential was controlled, finish annealing was performed at 1000° C., and then non-oriented electrical steel sheets were obtained.

[Table 1]

TABLE 1

| | | | | | | | FINISH | THICKNESS |
|---|---|---|---|---|---|---|---|---|
| | STEEL | | | | | FINISH | ANNEALING | OF Cr |
| | COMPONENT | | | 2[Si]+ | SHEET | ANNEALING | DURING | OXIDE LAYER |
| | (mass %) | | | 2[Al] + | THICKNESS | 300~500° C. | SOAKING | ON SURFACE |
| NO | Si | Al | Cr | [Cr] | mm | PH2O/PH2 | PH2O/PH2 | μm |
| 1 | 3.00 | 1.00 | 2.00 | 10 | 0.25 | 3 × 10⁻⁴ | 1 × 10⁻⁴ | 0.1 |
| 2 | 3.00 | 1.00 | 2.00 | 10 | 0.25 | 3 × 10⁻³ | 1 × 10⁻⁴ | 0.8 |
| 3 | 3.00 | 1.95 | 0.10 | 10 | 0.25 | 3 × 10⁻⁴ | 1 × 10⁻⁴ | UNDETECTABLE |

Next, a sample for magnetic measurement was cut out of each of the obtained non-oriented electrical steel sheets, of which a core loss W10/3000 at 3000 Hz and 1 T and a core loss W10/800 at 800 Hz and 1 T were measured. Further, a sample for observation was cut out and a cross section of each of the non-oriented electrical steel sheets was observed. As an observation method, by using a SEM and GDS, the thickness of a Cr oxide layer was measured. As a result, the thickness of each of the Cr oxide layers was as shown in Table 1. Further, samples No. 1 to No. 3 each resulted in 2[Si]+2[Al]+[Cr]=10 and (2[Al]+[Cr])/2[Si]−10t²=0.053. In Table 2 below, measurement results of the core loss are shown.

TABLE 2

| | W10/3000 | W10/800 | |
|---|---|---|---|
| No | W/kg | W/kg | NOTE |
| 1 | 260 | 29.6 | PRESENT |
| | | | INVENTION |
| | | | RANGE |
| 2 | 267 | 31.3 | OUTSIDE |
| | | | INVENTION |
| | | | RANGE |
| 3 | 266 | 30.9 | OUTSIDE |
| | | | INVENTION |
| | | | RANGE |

As shown in Table 2, in the sample No. 1 being the present invention example, the core loss was excellent at both the frequencies of 3000 Hz and 800 Hz. On the other hand, the sample No. 2 being the comparative example had the same components as those of the sample No. 1, but had the high oxygen potential at the time of increasing the temperature in the finish annealing, and thus the thickness of the Cr oxide layer became 0.8 μm and the core loss W10/3000 and the core loss W10/800 both became larger than those in the sample No. 1. Further, it is inferred that the sample No. 3 had the small Cr content, and thus the Cr oxide layer was undetectable and the thickness was less than 0.01 μm. As a result, it is inferred that an internal oxide layer of Si and Al was generated, and the core loss W10/3000 and the core loss W10/800 both became larger than those in the sample No. 1.

### Example 2

First, hot-rolled sheets each containing C: 0.002 mass %, S: 0.002 mass %, N: 0.002 mass %, and Mn: 0.3 mass %, and having a component A to a component L of Si, Al, and Cr shown in Table 3 below were prepared and were each subjected to pickling to be cold rolled, to thereby obtain cold-rolled sheets each having a thickness of 0.15 mm to 0.30 mm. Next, in a dry hydrogen atmosphere, finish annealing was performed at 1000° C. An oxygen potential P_{H2O}/P_{H2} at that time was set to 3×10⁻⁴ at 300 to 500° C. at the time of increasing the temperature, and was set to 1×10⁻⁴ during soaking, and then non-oriented electrical steel sheets were obtained.

TABLE 3

| COMPONENT | STEEL COMPONENT (mass %) | | | |
|---|---|---|---|---|
| No | Si | Al | Cr | 2 [Si] + 2 [Al] + [Cr] |
| A | 3.00 | 1.25 | 0.50 | 9 |
| B | 3.00 | 1.00 | 1.00 | 9 |
| C | 2.50 | 1.25 | 1.50 | 9 |
| D | 3.50 | 1.00 | 1.00 | 10 |
| E | 3.00 | 1.00 | 2.00 | 10 |
| F | 3.00 | 1.50 | 1.00 | 10 |
| G | 2.00 | 2.00 | 2.00 | 10 |
| H | 3.00 | 2.00 | 1.00 | 11 |
| I | 3.50 | 1.50 | 1.00 | 11 |
| J | 4.00 | 1.00 | 1.00 | 11 |
| K | 3.50 | 1.50 | 2.00 | 12 |
| L | 4.00 | 1.00 | 2.00 | 12 |

Next, a sample for magnetic measurement was cut out of each of the obtained non-oriented electrical steel sheets, of which the core loss W10/3000 at 3000 Hz and 1 T, the core loss W10/800 at 800 Hz and 1 T, and a core loss W10/400 at 400 Hz and 1 T were measured. Further, by procedures similar to those in Example 1, the thickness of each of Cr oxide layers was measured, resulting in that the thickness of the Cr oxide layer fell within a range of 0.01 μm to 0.5 μm in all samples. First, measurement results of the core loss W10/3000 and the core loss W10/800 are shown in Table 4 and Table 5 below. Incidentally, (2[Al]+[Cr])/2[Si]−10t² of each of the samples was calculated, resulting in that results shown Table 4 and Table 5 below were obtained.

TABLE 4

| | | | | | (2[Al] + | | |
|---|---|---|---|---|---|---|---|
| | | 2[Si] + | SHEET | | [Cr])/2 | | |
| | COMPONENT | 2[Al] + | THICKNESS | W10/3000 | [Si] − | W10/800 | |
| No | No | [Cr] | mm | W/kg | 10t² | W/kg | NOTE |
| 101 | A | 9 | 0.15 | 170 | 0.28 | 21.1 | OUTSIDE |
| | | | | | | | INVENTION |
| | | | | | | | RANGE |
| 102 | B | 9 | 0.15 | 170 | 0.28 | 21.1 | OUTSIDE |
| | | | | | | | INVENTION |
| | | | | | | | RANGE |
| 103 | C | 9 | 0.15 | 172 | 0.58 | 22.2 | OUTSIDE |
| | | | | | | | INVENTION |
| | | | | | | | RANGE |
| 104 | D | 10 | 0.15 | 158 | 0.20 | 20.0 | PRESENT |
| | | | | | | | INVENTION |
| | | | | | | | RANGE |
| 105 | E | 10 | 0.15 | 160 | 0.44 | 20.9 | OUTSIDE |
| | | | | | | | INVENTION |
| | | | | | | | RANGE |
| 106 | F | 10 | 0.15 | 160 | 0.44 | 20.9 | OUTSIDE |
| | | | | | | | INVENTION |
| | | | | | | | RANGE |
| 107 | G | 10 | 0.15 | 167 | 1.28 | 24.1 | OUTSIDE |
| | | | | | | | INVENTION |
| | | | | | | | RANGE |
| 108 | H | 11 | 0.15 | 153 | 0.61 | 20.8 | OUTSIDE |
| | | | | | | | INVENTION |
| | | | | | | | RANGE |
| 109 | I | 11 | 0.15 | 150 | 0.35 | 19.8 | PRESENT |
| | | | | | | | INVENTION |
| | | | | | | | RANGE |
| 110 | J | 11 | 0.15 | 149 | 0.15 | 19.1 | PRESENT |
| | | | | | | | INVENTION |
| | | | | | | | RANGE |
| 111 | K | 12 | 0.15 | 144 | 0.49 | 20.0 | OUTSIDE |
| | | | | | | | INVENTION |
| | | | | | | | RANGE |
| 112 | L | 12 | 0.15 | 142 | 0.28 | 19.0 | PRESENT |
| | | | | | | | INVENTION |
| | | | | | | | RANGE |
| 113 | A | 9 | 0.20 | 223 | 0.10 | 25.6 | OUTSIDE |
| | | | | | | | INVENTION |
| | | | | | | | RANGE |
| 114 | B | 9 | 0.20 | 223 | 0.10 | 25.6 | OUTSIDE |
| | | | | | | | INVENTION |
| | | | | | | | RANGE |
| 115 | C | 9 | 0.20 | 225 | 0.40 | 26.8 | OUTSIDE |
| | | | | | | | INVENTION |
| | | | | | | | RANGE |
| 116 | D | 10 | 0.20 | 205 | 0.03 | 24.0 | PRESENT |
| | | | | | | | INVENTION |
| | | | | | | | RANGE |
| 117 | E | 10 | 0.20 | 207 | 0.27 | 25.0 | PRESENT |
| | | | | | | | INVENTION |
| | | | | | | | RANGE |
| 118 | F | 10 | 0.20 | 207 | 0.27 | 25.0 | PRESENT |
| | | | | | | | INVENTION |
| | | | | | | | RANGE |
| 119 | G | 10 | 0.20 | 215 | 1.10 | 28.1 | OUTSIDE |
| | | | | | | | INVENTION |
| | | | | | | | RANGE |
| 120 | H | 11 | 0.20 | 195 | 0.43 | 25.2 | OUTSIDE |
| | | | | | | | INVENTION |
| | | | | | | | RANGE |
| 121 | I | 11 | 0.20 | 193 | 0.17 | 23.5 | PRESENT |
| | | | | | | | INVENTION |
| | | | | | | | RANGE |
| 122 | J | 11 | 0.20 | 191 | −0.03 | 22.8 | PRESENT |
| | | | | | | | INVENTION |
| | | | | | | | RANGE |
| 123 | K | 12 | 0.20 | 183 | 0.31 | 23.2 | PRESENT |
| | | | | | | | INVENTION |
| | | | | | | | RANGE |
| 124 | L | 12 | 0.20 | 181 | 0.10 | 22.4 | PRESENT |
| | | | | | | | INVENTION |
| | | | | | | | RANGE |
| 125 | A | 9 | 0.25 | 283 | −0.13 | 30.8 | OUTSIDE |
| | | | | | | | INVENTION |
| | | | | | | | RANGE |
| 126 | B | 9 | 0.25 | 283 | −0.13 | 30.8 | OUTSIDE |
| | | | | | | | INVENTION |
| | | | | | | | RANGE |
| 127 | C | 9 | 0.25 | 285 | 0.18 | 31.9 | OUTSIDE |
| | | | | | | | INVENTION |
| | | | | | | | RANGE |
| 128 | D | 10 | 0.25 | 258 | −0.20 | 28.7 | PRESENT |
| | | | | | | | INVENTION |
| | | | | | | | RANGE |
| 129 | E | 10 | 0.25 | 260 | 0.04 | 29.6 | PRESENT |
| | | | | | | | INVENTION |
| | | | | | | | RANGE |
| 130 | F | 10 | 0.25 | 260 | 0.04 | 29.6 | PRESENT |
| | | | | | | | INVENTION |
| | | | | | | | RANGE |
| 131 | G | 10 | 0.25 | 268 | 0.88 | 32.8 | OUTSIDE |
| | | | | | | | INVENTION |
| | | | | | | | RANGE |
| 132 | H | 11 | 0.25 | 243 | 0.21 | 28.7 | PRESENT |
| | | | | | | | INVENTION |
| | | | | | | | RANGE |
| 133 | I | 11 | 0.25 | 240 | −0.05 | 27.7 | PRESENT |
| | | | | | | | INVENTION |
| | | | | | | | RANGE |

TABLE 5

| | | | | | (2[Al] + | | |
|---|---|---|---|---|---|---|---|
| | | 2[Si] + | SHEET | | [Cr])/2 | | |
| | COMPONENT | 2[Al] + | THICKNESS | W10/3000 | [Si] − | W10/800 | |
| No | No | [Cr] | mm | W/kg | 10t² | W/kg | NOTE |
| 134 | J | 11 | 0.25 | 239 | −0.25 | 27.0 | PRESENT |
| | | | | | | | INVENTION |
| | | | | | | | RANGE |
| 135 | K | 12 | 0.25 | 226 | 0.09 | 27.1 | PRESENT |
| | | | | | | | INVENTION |
| | | | | | | | RANGE |
| 136 | L | 12 | 0.25 | 224 | −0.13 | 26.2 | PRESENT |
| | | | | | | | INVENTION |
| | | | | | | | RANGE |
| 137 | A | 9 | 0.30 | 348 | −0.40 | 36.4 | OUTSIDE |
| | | | | | | | INVENTION |
| | | | | | | | RANGE |
| 138 | B | 9 | 0.30 | 348 | −0.40 | 36.4 | OUTSIDE |
| | | | | | | | INVENTION |
| | | | | | | | RANGE |
| 139 | C | 9 | 0.30 | 350 | −0.10 | 37.6 | OUTSIDE |
| | | | | | | | INVENTION |
| | | | | | | | RANGE |
| 140 | D | 10 | 0.30 | 316 | −0.47 | 33.8 | PRESENT |
| | | | | | | | INVENTION |
| | | | | | | | RANGE |
| 141 | E | 10 | 0.30 | 318 | −0.23 | 34.7 | PRESENT |
| | | | | | | | INVENTION |
| | | | | | | | RANGE |
| 142 | F | 10 | 0.30 | 318 | −0.23 | 34.7 | PRESENT |
| | | | | | | | INVENTION |
| | | | | | | | RANGE |
| 143 | G | 10 | 0.30 | 325 | 0.60 | 37.9 | OUTSIDE |
| | | | | | | | INVENTION |
| | | | | | | | RANGE |
| 144 | H | 11 | 0.30 | 294 | −0.07 | 33.4 | PRESENT |
| | | | | | | | INVENTION |
| | | | | | | | RANGE |
| 145 | I | 11 | 0.30 | 292 | −0.33 | 32.4 | PRESENT |
| | | | | | | | INVENTION |
| | | | | | | | RANGE |
| 146 | J | 11 | 0.30 | 290 | −0.53 | 31.6 | PRESENT |
| | | | | | | | INVENTION |
| | | | | | | | RANGE |
| 147 | K | 12 | 0.30 | 272 | −0.19 | 31.3 | PRESENT |
| | | | | | | | INVENTION |
| | | | | | | | RANGE |
| 148 | L | 12 | 0.30 | 270 | −0.40 | 30.5 | PRESENT |
| | | | | | | | INVENTION |
| | | | | | | | RANGE |

As shown in Table 4 and Table 5, the samples with the components A to C being the comparative example each satisfied 2[Si]+2[Al]+[Cr]<10 mass %, and thus as compared with the ones each having the same sheet thickness, the core loss W10/3000 was large. The samples with the components D to L each satisfied 2[Si]+2[Al]+[Cr]≧10 mass %, and as compared with the samples with the components A to C each having the same sheet thickness, the core loss W10/3000 was small. However, in the samples each satisfying (2 [Al]+[Cr])/2 [Si]−10t²>0.35, the core loss W10/800 was large as compared with the ones each having the same sheet thickness.

In Table 6 and Table 7 below, measurement results of the core loss W10/3000 and the core loss W10/400 are shown. Incidentally, (2[Al]+[Cr])/2[Si]−5t² of each of the samples was calculated, resulting in that results shown in Table 6 and Table 7 below were obtained.

TABLE 6

| | | | | | (2[Al]+ | | |
|---|---|---|---|---|---|---|---|
| | | 2[Si] + | SHEET | | [Cr])/2 | | |
| | COMPONENT | 2[Al] + | THICKNESS | W10/3000 | [Si] − | W10/400 | |
| No | No | [Cr] | mm | W/kg | 5t² | W/kg | NOTE |
| 101 | A | 9 | 0.15 | 170 | 0.39 | 8.6 | OUTSIDE |
| | | | | | | | INVENTION |
| | | | | | | | RANGE |
| 102 | B | 9 | 0.15 | 170 | 0.39 | 8.6 | OUTSIDE |
| | | | | | | | INVENTION |
| | | | | | | | RANGE |
| 103 | C | 9 | 0.15 | 172 | 0.69 | 9.2 | OUTSIDE |
| | | | | | | | INVENTION |
| | | | | | | | RANGE |
| 104 | D | 10 | 0.15 | 158 | 0.32 | 8.3 | PRESENT |
| | | | | | | | INVENTION |
| | | | | | | | RANGE |
| 105 | E | 10 | 0.15 | 160 | 0.55 | 8.7 | OUTSIDE |
| | | | | | | | INVENTION |
| | | | | | | | RANGE |
| 106 | F | 10 | 0.15 | 160 | 0.55 | 8.7 | OUTSIDE |
| | | | | | | | INVENTION |
| | | | | | | | RANGE |
| 107 | G | 10 | 0.15 | 167 | 1.39 | 10.3 | OUTSIDE |
| | | | | | | | INVENTION |
| | | | | | | | RANGE |
| 108 | H | 11 | 0.15 | 153 | 0.72 | 8.9 | OUTSIDE |
| | | | | | | | INVENTION |
| | | | | | | | RANGE |
| 109 | I | 11 | 0.15 | 150 | 0.46 | 8.4 | OUTSIDE |
| | | | | | | | INVENTION |
| | | | | | | | RANGE |
| 110 | J | 11 | 0.15 | 149 | 0.26 | 8.0 | PRESENT |
| | | | | | | | INVENTION |
| | | | | | | | RANGE |
| 111 | K | 12 | 0.15 | 144 | 0.60 | 8.5 | OUTSIDE |
| | | | | | | | INVENTION |
| | | | | | | | RANGE |
| 112 | L | 12 | 0.15 | 142 | 0.39 | 8.3 | OUTSIDE |
| | | | | | | | INVENTION |
| | | | | | | | RANGE |
| 113 | A | 9 | 0.20 | 223 | 0.30 | 9.9 | OUTSIDE |
| | | | | | | | INVENTION |
| | | | | | | | RANGE |
| 114 | B | 9 | 0.20 | 223 | 0.30 | 9.9 | OUTSIDE |
| | | | | | | | INVENTION |
| | | | | | | | RANGE |
| 115 | C | 9 | 0.20 | 225 | 0.60 | 10.4 | OUTSIDE |
| | | | | | | | INVENTION |
| | | | | | | | RANGE |
| 116 | D | 10 | 0.20 | 205 | 0.23 | 9.2 | PRESENT |
| | | | | | | | INVENTION |
| | | | | | | | RANGE |
| 117 | E | 10 | 0.20 | 207 | 0.47 | 9.8 | OUTSIDE |
| | | | | | | | INVENTION |
| | | | | | | | RANGE |
| 118 | F | 10 | 0.20 | 207 | 0.47 | 9.8 | OUTSIDE |
| | | | | | | | INVENTION |
| | | | | | | | RANGE |
| 119 | G | 10 | 0.20 | 215 | 1.30 | 11.4 | OUTSIDE |
| | | | | | | | INVENTION |
| | | | | | | | RANGE |
| 120 | H | 11 | 0.20 | 195 | 0.63 | 9.9 | OUTSIDE |
| | | | | | | | INVENTION |
| | | | | | | | RANGE |
| 121 | I | 11 | 0.20 | 193 | 0.37 | 9.4 | OUTSIDE |
| | | | | | | | INVENTION |
| | | | | | | | RANGE |
| 122 | J | 11 | 0.20 | 191 | 0.18 | 9.0 | PRESENT |
| | | | | | | | INVENTION |
| | | | | | | | RANGE |
| 123 | K | 12 | 0.20 | 183 | 0.51 | 9.4 | OUTSIDE |
| | | | | | | | INVENTION |
| | | | | | | | RANGE |
| 124 | L | 12 | 0.20 | 181 | 0.30 | 9.0 | PRESENT |
| | | | | | | | INVENTION |
| | | | | | | | RANGE |
| 125 | A | 9 | 0.25 | 283 | 0.19 | 11.3 | OUTSIDE |
| | | | | | | | INVENTION |
| | | | | | | | RANGE |
| 126 | B | 9 | 0.25 | 283 | 0.19 | 11.3 | OUTSIDE |
| | | | | | | | INVENTION |
| | | | | | | | RANGE |
| 127 | C | 9 | 0.25 | 285 | 0.49 | 11.8 | OUTSIDE |
| | | | | | | | INVENTION |
| | | | | | | | RANGE |
| 128 | D | 10 | 0.25 | 258 | 0.12 | 10.6 | PRESENT |
| | | | | | | | INVENTION |
| | | | | | | | RANGE |
| 129 | E | 10 | 0.25 | 260 | 0.35 | 11.1 | PRESENT |
| | | | | | | | INVENTION |
| | | | | | | | RANGE |
| 130 | F | 10 | 0.25 | 260 | 0.35 | 11.1 | PRESENT |
| | | | | | | | INVENTION |
| | | | | | | | RANGE |
| 131 | G | 10 | 0.25 | 268 | 1.19 | 12.7 | OUTSIDE |
| | | | | | | | INVENTION |
| | | | | | | | RANGE |
| 132 | H | 11 | 0.25 | 243 | 0.52 | 11.6 | OUTSIDE |
| | | | | | | | INVENTION |
| | | | | | | | RANGE |
| 133 | I | 11 | 0.25 | 240 | 0.26 | 10.5 | PRESENT |
| | | | | | | | INVENTION |
| | | | | | | | RANGE |

TABLE 7

| | | | | | (2[A1] + | | |
|---|---|---|---|---|---|---|---|
| | | 2[Si] + | SHEET | | [Cr])/2 | | |
| | COMPONENT | 2[Al] + | THICKNESS | W10/3000 | [Si] − | W10/400 | |
| No | No | [Cr] | mm | W/kg | 5t² | W/kg | NOTE |
| 134 | J | 11 | 0.25 | 239 | 0.06 | 10.1 | PRESENT |
| | | | | | | | INVENTION |
| | | | | | | | RANGE |
| 135 | K | 12 | 0.25 | 226 | 0.40 | 10.4 | OUTSIDE |
| | | | | | | | INVENTION |
| | | | | | | | RANGE |
| 136 | L | 12 | 0.25 | 224 | 0.19 | 10.0 | PRESENT |
| | | | | | | | INVENTION |
| | | | | | | | RANGE |
| 137 | A | 9 | 0.30 | 348 | 0.05 | 12.8 | OUTSIDE |
| | | | | | | | INVENTION |
| | | | | | | | RANGE |
| 138 | B | 9 | 0.30 | 348 | 0.05 | 12.8 | OUTSIDE |
| | | | | | | | INVENTION |
| | | | | | | | RANGE |
| 139 | C | 9 | 0.30 | 350 | 0.35 | 13.4 | OUTSIDE |
| | | | | | | | INVENTION |
| | | | | | | | RANGE |
| 140 | D | 10 | 0.30 | 316 | −0.02 | 12.0 | PRESENT |
| | | | | | | | INVENTION |
| | | | | | | | RANGE |
| 141 | E | 10 | 0.30 | 318 | 0.22 | 12.5 | PRESENT |
| | | | | | | | INVENTION |
| | | | | | | | RANGE |
| 142 | F | 10 | 0.30 | 318 | 0.22 | 12.5 | PRESENT |
| | | | | | | | INVENTION |
| | | | | | | | RANGE |
| 143 | G | 10 | 0.30 | 325 | 1.05 | 14.1 | OUTSIDE |
| | | | | | | | INVENTION |
| | | | | | | | RANGE |
| 144 | H | 11 | 0.30 | 294 | 0.38 | 12.7 | OUTSIDE |
| | | | | | | | INVENTION |
| | | | | | | | RANGE |
| 145 | I | 11 | 0.30 | 292 | 0.12 | 11.8 | PRESENT |
| | | | | | | | INVENTION |
| | | | | | | | RANGE |
| 146 | J | 11 | 0.30 | 290 | −0.08 | 11.4 | PRESENT |
| | | | | | | | INVENTION |
| | | | | | | | RANGE |
| 147 | K | 12 | 0.30 | 272 | 0.26 | 11.6 | PRESENT |
| | | | | | | | INVENTION |
| | | | | | | | RANGE |
| 148 | L | 12 | 0.30 | 270 | 0.05 | 11.2 | PRESENT |
| | | | | | | | INVENTION |
| | | | | | | | RANGE |

As shown in Table 6 and Table 7, as for each of the components D to L, 2[Si]+2[Al]+[Cr]≧10 mass % was satisfied, but in the samples each satisfying (2[Al]+[Cr])/2[Si]−5t²>0.35, the core loss W10/400 was large as compared with the ones each having the same sheet thickness.

### INDUSTRIAL APPLICABILITY

According to the present invention, it is possible to utilize a non-oriented electrical steel sheet as a material of a motor core to be rotated at high speed and to be driven at high frequency in an electric vehicle, a hybrid vehicle, and the like.

1. A non-oriented electrical steel sheet comprising:
C: 0.005 mass % or less; S: 0.003 mass % or less; N: 0.003 mass % or less; Si: 2.0 mass % or more and less than 4.5 mass %; Al: 0.15 mass % or more and less than 2.5 mass %; and Cr: 0.3 mass % or more and less than 5.0 mass %; and a balance being composed of Fe and inevitable impurities; and a Cr-oxide-containing layer having a thickness of not less than 0.01 μm nor more than 0.5 μm on a surface side, wherein
Expression 1 and Expression 2 below are further satisfied, and a sheet thickness of the non-oriented electrical steel sheet is 0.3 mm or less,
10 mass %≦2[Si]+2[Al]+[Cr]<15 mass % Expression 1
(2[Al]+[Cr])/2[Si]−10t²≦0.35 Expression 2
(Here, [Si], [Al], and [Cr] represent the Si content, the Al content, and the Cr content (mass %) of the non-oriented electrical steel sheet respectively, and t represents a sheet thickness (mm) of the non-oriented electrical steel sheet.)

2. The non-oriented electrical steel sheet according to claim 1, wherein
Expression 3 below is further satisfied.
(2[Al]+[Cr])/2[Si]−5t²≦0.35 Expression 3

3. The non-oriented electrical steel sheet according to claim 1, further comprising:
Mn: not less than 0.2 mass % nor more than 1.5 mass %.

4. The non-oriented electrical steel sheet according to claim 1, wherein
the non-oriented electrical steel sheet is manufactured by setting an oxygen potential at 300° C. to 500° C. at the time of increasing the temperature to 10⁻³ or less in the finish annealing.

5. The non-oriented electrical steel sheet according to claim 2, wherein
the non-oriented electrical steel sheet is manufactured by setting an oxygen potential at 300° C. to 500° C. at the time of increasing the temperature to 10⁻³ or less in the finish annealing.

6. The non-oriented electrical steel sheet according to claim 3, wherein
the non-oriented electrical steel sheet is manufactured by setting an oxygen potential at 300° C. to 500° C. at the time of increasing the temperature to 10⁻³ or less in the finish annealing.
